(19) United States
(12) Patent Application Publication
(10) Pub. No.: US 2026/0330385 A1
(43) Pub. Date: Oct. 22, 2026

(54) SYSTEMS, APPARATUSES, METHODS, AND COMPUTER PROGRAM PRODUCTS FOR AN INTERACTIVE PROJECT REQUIREMENTS ANALYSIS ENGINE

(71) Applicant: Honeywell International Inc., Charlotte, NC (US)

(72) Inventors: Anil PALLAYIL, Charlotte, NC (US); Rahul SHARMA, Houston, TX (US); Honey RAGHAVAN, Bangalore (IN)

(21) Appl. No.: 19/651,406

(22) Filed: Apr. 17, 2026

Related U.S. Application Data
(60) Provisional application No. 63/790,876, filed on Apr. 18, 2025.

(51) Int. Cl. G06Q 10/0637; G06N 5/02

(52) U.S. Cl. CPC G06Q 10/06375; G06N 5/027

(57) ABSTRACT

Systems, apparatuses, methods, and computer program products are provided herein. For example, a method may include receiving a project and corresponding project metadata. The method may further include analyzing the project metadata to identify one or more project requirements. The method may further include identifying one or more similar historical projects based at least in part on the project metadata and the one or more project requirements. The method may further include detecting one or more incomplete project requirements based on the identified one or more similar historical projects. The method may further include generating an interface comprising one or more prompts configured to facilitate user feedback associated with the one or more incomplete project requirements. The method may further include detecting one or more user interactions with the generated interface. The method may include updating the one or more project requirements based on the one or more user interactions.

### CROSS-REFERENCE TO RELATED APPLICATIONS

This application claims priority and benefit to U.S. Provisional Patent Application No. 63/790,876, filed Apr. 18, 2025, the contents of which are incorporated herein by reference in its entirety.

### TECHNOLOGICAL FIELD

Embodiments of the present disclosure relate generally to systems, apparatuses, methods, and computer program products for an interactive project requirements analysis engine.

### BACKGROUND

Applicant has identified many technical challenges and difficulties associated with systems, apparatuses, methods, and computer program products for an interactive project requirements analysis engine. Through applied effort, ingenuity, and innovation, Applicant has solved problems related to systems, apparatuses, methods, and computer program products for an interactive project requirements analysis engine by developing solutions embodied in the present disclosure, which are described in detail below.

### BRIEF SUMMARY

Various embodiments described herein relate to systems, apparatuses, methods, and computer program products for interactive project requirements analysis.

In accordance with one aspect of the disclosure a method is provided. In some embodiments, the method comprises receiving, by one or more processors, a subject project and a set of project metadata corresponding to the subject project. In some embodiments, the method comprises analyzing, by the one or more processors, the set of project metadata to identify one or more project requirements. In some embodiments, identifying, by the one or more processors, one or more similar historical projects based at least in part on the set of project metadata and the one or more project requirements. In some embodiments, the method comprises detecting, by the one or more processors, one or more incomplete project requirements based on the identified one or more similar historical projects. In some embodiments, the method comprises generating, by the one or more processors, an interface comprising one or more prompts configured to facilitate user feedback associated with the one or more incomplete project requirements. In some embodiments, the method comprises detecting, by the one or more processors, one or more user interactions with the generated interface. In some embodiments, the method comprises generating, by the one or more processors, one or more updated project requirements based on the one or more user interactions and the one or more incomplete project requirements.

In accordance with some aspects of the disclosure, analyzing the set of project metadata to identify one or more project requirements comprises extracting one or more project features from the set of project metadata and identifying one or more project requirements corresponding to the one or more project features.

In accordance with some aspects of the disclosure, detecting one or more incomplete project requirements based on the identified one or more similar historical projects comprises analyzing the one or more similar historical projects to identify one or more historical project requirements which are not included in the one or more project requirements.

In accordance with some aspects of the disclosure, generating an interface comprising one or more prompts configured to facilitate user feedback associated with the one or more incomplete project requirements comprises generating one or more user-editable text prompts via which a user can provide project requirements information corresponding to the one or more incomplete project requirements.

In accordance with some aspects of the disclosure, the method further includes generating, by the one or more processors, an updated project proposal comprising the one or more updated project requirements.

In accordance with some aspects of the disclosure, the method further includes transmitting, by the one or more processors, the updated project proposal comprising the one or more updated project requirements to an external system.

In accordance with some aspects of the disclosure, identifying one or more similar historical projects comprises, for each subject historical project of a plurality of historical projects available via a historical project database, determining a similarity score between the one or more project features and one or more historical project features of the subject historical project, and identifying one or more similar historical projects of the plurality of historical projects based at least in part on the similarity score exceeding a defined similarity score threshold.

In accordance with another aspect of the disclosure, an apparatus is provided. In some embodiments, the apparatus includes memory and one or more processors communicatively coupled to the memory. In some embodiments, the one or more processors are configured to perform operations comprising receiving a subject project and a set of project metadata corresponding to the subject project. In some embodiments, the one or more processors are configured to perform operations comprising analyzing the set of project metadata to identify one or more project requirements. In some embodiments, the one or more processors are configured to perform operations comprising identifying one or more similar historical projects based at least in part on the set of project metadata and the one or more project requirements. In some embodiments, the one or more processors are configured to perform operations comprising detecting one or more incomplete project requirements based on the identified similar historical projects. In some embodiments, the one or more processors are configured to perform operations comprising generating an interface comprising one or more prompts configured to facilitate user feedback associated with the one or more incomplete project requirements. In some embodiments, the one or more processors are configured to perform operations comprising detecting one or more user interactions with the generated interface. In some embodiments, the one or more processors are configured to perform operations comprising generating one or more updated project requirements based on the one or more user interactions and the one or more incomplete project requirements.

In accordance with some aspects of the disclosure, the apparatus is configured to analyze the set of project metadata to identify one or more project requirements by extracting one or more project features from the set of project metadata and identifying one or more project requirements corresponding to the one or more project features.

In accordance with some aspects of the disclosure, the apparatus is configured to detect one or more incomplete project requirements based on the identified one or more similar historical projects by analyzing the one or more similar historical projects to identify one or more historical project requirements which are not included in the one or more project requirements.

In accordance with some aspects of the disclosure, the apparatus is configured to generate an interface comprising one or more prompts configured to facilitate user feedback associated with the one or more incomplete project requirements by generating one or more user-editable text prompts via which a user can provide project requirements information corresponding to the one or more incomplete project requirements.

In accordance with some aspects of the disclosure, the apparatus is further configured to generate an updated project proposal comprising the one or more updated project requirements.

In accordance with some aspects of the disclosure, the apparatus is further configured to transmit the updated project proposal comprising the one or more updated project requirements to an external system.

In accordance with some aspects of the disclosure, the apparatus is configured to identify one or more similar historical projects by, for each subject historical project of a plurality of historical projects available via a historical project database, determining a similarity score between the one or more project features and one or more historical project features of the subject historical project, and identifying one or more similar historical projects of the plurality of historical projects based at least in part on the similarity score exceeding a defined similarity score threshold.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for receiving a subject project and a set of project metadata corresponding to the subject project. In some embodiments, the computer program code, in execution with at least one processor, configures the computer program product for analyzing the set of project metadata to identify one or more project requirements. In some embodiments, the computer program code, in execution with at least one processor, configures the computer program product for identifying one or more similar historical projects based at least in part on the set of project metadata and the one or more project requirements. In some embodiments, the computer program code, in execution with at least one processor, configures the computer program product for detecting one or more incomplete project requirements based on the identified similar historical projects. In some embodiments, the computer program code, in execution with at least one processor, configures the computer program product for generating an interface comprising one or more prompts configured to facilitate user feedback associated with the one or more incomplete project requirements. In some embodiments, the computer program code, in execution with at least one processor, configures the computer program product for detecting one or more user interactions with the generated interface. In some embodiments, the computer program code, in execution with at least one processor, configures the computer program product for generating one or more updated project requirements based on the one or more user interactions and the one or more incomplete project requirements.

In accordance with some aspects of the disclosure, the computer program code, in execution with at least one processor, configures the computer program product for analyzing the set of project metadata to identify one or more project requirements by extracting one or more project features from the set of project metadata and identifying one or more project requirements corresponding to the one or more project features.

In accordance with some aspects of the disclosure, the computer program code, in execution with at least one processor, configures the computer program product for detecting one or more incomplete project requirements based on the identified one or more similar historical projects by analyzing the one or more similar historical projects to identify one or more historical project requirements which are not included in the one or more project requirements.

In accordance with some aspects of the disclosure, the computer program code, in execution with at least one processor, configures the computer program product for generating an interface comprising one or more prompts configured to facilitate user feedback associated with the one or more incomplete project requirements by generating one or more user-editable text prompts via which a user can provide project requirements information corresponding to the one or more incomplete project requirements.

In accordance with some aspects of the disclosure, the computer program code, in execution with at least one processor, configures the computer program product for generating an updated project proposal comprising the one or more updated project requirements.

In accordance with some aspects of the disclosure, , the computer program code, in execution with at least one processor, configures the computer program product for transmitting the updated project proposal comprising the one or more updated project requirements to an external system.

In accordance with some aspects of the disclosure, the computer program code, in execution with at least one processor, configures the computer program product for identifying one or more similar historical projects by, for each subject historical project of a plurality of historical projects available via a historical project database, determining a similarity score between the one or more project features and one or more historical project features of the subject historical project, and identifying one or more similar historical projects of the plurality of historical projects based at least in part on the similarity score exceeding a defined similarity score threshold.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of the environment in which embodiments of the present disclosure may operate;

FIG. 3 illustrates an example block diagram of an example apparatus that may be specially configured in accordance with an example embodiment of the present disclosure;

FIG. 4 illustrates an example project requirements component that may be specially configured in accordance with an example embodiment of the present disclosure.

FIG. 5 illustrates an example project requirements component that may be specially configured in accordance with an example embodiment of the present disclosure.

FIG. 6 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### OVERVIEW

Example embodiments disclosed herein address technical problems associated with systems, apparatuses, methods, and computer program products for project requirement analysis. As would be understood by one skilled in the field to which this disclosure pertains, there are numerous example scenarios in which systems, apparatuses, methods, and computer program products for project requirement analysis are desirable.

Example solutions for an interactive project requirements analysis engine using computing devices to implement project requirement analysis. However, such example solutions are simplistic, inefficient, and reactive. For example, such example solutions are simplistic because such example solutions do not implement a plurality of predictive computing entities to execute discrete tasks using generative artificial intelligence to implement project requirement analysis. As another example, such example solutions are inefficient because such example solutions do not leverage historical projects for implementing project requirement analysis. As another example, such example solutions are reactive because such example solutions do not automatically implement responsive actions based on updated project proposals. Accordingly, there is a need for systems, apparatuses, methods, and computer program products that perform new project generation in a sophisticated, an efficient, and a proactive manner.

Thus, to address these and/or other issues related to such example solutions, example systems, apparatuses, methods, and computer program products for an interactive project requirements analysis engine are disclosed herein. For example, an embodiment in this disclosure, described in greater detail below, includes a method that comprises receiving, by one or more processors, a subject project and a set of project metadata corresponding to the subject project. In some embodiments, the method comprises analyzing, by the one or more processors, the set of project metadata to identify one or more project requirements. In some embodiments, identifying, by the one or more processors, one or more similar historical projects based at least in part on the set of project metadata and the one or more project requirements. In some embodiments, the method comprises detecting, by the one or more processors, one or more incomplete project requirements based on the identified one or more similar historical projects. In some embodiments, the method comprises generating, by the one or more processors, an interface comprising one or more prompts configured to facilitate user feedback associated with the one or more incomplete project requirements. In some embodiments, the method comprises detecting, by the one or more processors, one or more user interactions with the generated interface. In some embodiments, the method comprises generating, by the one or more processors, one or more updated project requirements based on the one or more user interactions and the one or more incomplete project requirements. Accordingly, the systems, apparatuses, methods, and computer program products enable project requirement analysis in a sophisticated, an efficient, and a proactive manner.

Further embodiments and advantages of the example systems, apparatuses, methods, and computer program products disclosed herein are described in the following co-pending U.S. patent applications: U.S. Application No. 63/790,880, titled “SYSTEMS, APPARATUSES, METHODS, AND COMPUTER PROGRAM PRODUCTS FOR AUTOMATED PROJECT OPERATIONS ARCHITECTURE”; U.S. Application No. 63/790,873, titled “SYSTEMS, APPARATUSES, METHODS, AND COMPUTER PROGRAM PRODUCTS FOR A PROJECT OUTCOME PREDICTIVE ENGINE”; U.S. Application No. 63/790,878, titled “SYSTEMS, APPARATUSES, METHODS, AND COMPUTER PROGRAM PRODUCTS FOR NEW PROJECT GENERATION”; U.S. Application No. 63/790,875, titled “SYSTEMS, APPARATUSES, METHODS, AND COMPUTER PROGRAM PRODUCTS FOR GENERATING A NEW PHYSICAL COMPONENT”; U.S. Application No. 63/790,882, titled “SYSTEMS, APPARATUSES, METHODS, AND COMPUTER PROGRAM PRODUCTS FOR REAL-TIME PROJECT INVENTORY OPTIMIZATION”; U.S. Application No. 63/790,885, titled “SYSTEMS, APPARATUSES, METHODS, AND COMPUTER PROGRAM PRODUCTS FOR REAL-TIME PROJECT SERVICES OPERATIONS”; U.S. Application No. 63/790,889, titled “SYSTEMS, APPARATUSES, METHODS, AND COMPUTER PROGRAM PRODUCTS FOR PROJECT PROGRAM GENERATION”; U.S. Application No. 63/790,892, titled “SYSTEMS, APPARATUSES, METHODS, AND COMPUTER PROGRAM PRODUCTS FOR AUTOMATED PROJECT QUALITY CONTROL”; U.S. Application No. 63/790,879, titled “SYSTEMS, APPARATUSES, METHODS, AND COMPUTER PROGRAM PRODUCTS FOR AI DRIVEN PROJECT COMPLIANCE FORECASTING”, each of which is filed concurrently with the present application. The contents of each of the foregoing applications are hereby incorporated by reference in their entirety.

### EXAMPLE SYSTEMS AND APPARATUSES

Embodiments of the present disclosure herein include systems, apparatuses, methods, and computer program products configured for an interactive project requirements analysis engine. It should be readily appreciated that the embodiments of the apparatus, systems, methods, and computer program product described herein may be configured in various additional and alternative manners in addition to those expressly described herein.

Additionally, or alternatively, in some embodiments, the cloud-based project operations device 140 is configured via hardware, software, firmware, and/or a combination thereof, to generate and/or transmit command(s) that control, adjust, or otherwise impact operations of one or more of the project foundation device 180, the external project implementation device 120, the external project application device 110, the one or more databases 150, and/or the user device 170. Additionally, or alternatively, in some embodiments, the cloud-based project operations device 140 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the external project application device 110, the one or more databases 150, and/or the user device 170. For example, in various embodiments, the cloud-based project operations device 140 may be configured to execute and/or perform one or more operations and/or functions described herein.

In some embodiments, the environment 100 comprises the external project implementation device 120. In some embodiments, the external project implementation device 120 is electronically and/or communicatively coupled to the project foundation device 180, the external project application device 110, the cloud-based project operations device 140, the one or more databases 150, and/or the user device 170. The external project implementation device 120 may be located remotely from the project foundation device 180, the external project application device 110, the cloud-based project operations device 140, the one or more databases 150, and/or the user device 170. In this regard, for example, the external project implementation device 120 may be located in a remote cloud server and electronically and/or communicatively coupled to the project foundation device 180, the external project application device 110, the cloud-based project operations device 140, the one or more databases 150, and/or the user device 170 via at least the network 130. In some embodiments, the external project implementation device 120 is configured via hardware, software, firmware, and/or a combination thereof, to perform data intake of one or more types of data.

Additionally, or alternatively, in some embodiments, the external project implementation device 120 is configured via hardware, software, firmware, and/or a combination thereof, to generate and/or transmit command(s) that control, adjust, or otherwise impact operations of one or more of the project foundation device 180, the external project application device 110, the cloud-based project operations device 140, the one or more databases 150, and/or the user device 170. Additionally, or alternatively, in some embodiments, the external project implementation device 120 is configured via hardware, software, firmware, and/or a combination thereof, to perform data reporting, provide data, and/or other data output process(es) associated with monitoring or otherwise analyzing operations of one or more of the project foundation device 180, the external project application device 110, the cloud-based project operations device 140, the one or more databases 150, and/or the user device 170. For example, in various embodiments, the external project implementation device 120 may be configured to execute and/or perform one or more operations and/or functions described herein.

In some embodiments, the environment 100 comprises an external project application device 110. In some embodiments, the external project application device 110 is electronically and/or communicatively coupled to the project foundation device 180, the external project implementation device 120, the cloud-based project operations device 140, the one or more databases 150, and/or the user device 170. The external project application device 110 may be located remotely from the project foundation device 180, the external project implementation device 120, the cloud-based project operations device 140, the one or more databases 150, and/or the user device 170. In this regard, for example, the external project application device 110 may be located in a remote cloud server and electronically and/or communicatively coupled to the project foundation device 180, the external project implementation device 120, the cloud-based project operations device 140, the one or more databases 150, and/or the user device 170 via at least the network 130. In some embodiments, the external project application device 110 is configured via hardware, software, firmware, and/or a combination thereof, to perform data intake of one or more types of data.

Additionally, or alternatively, in some embodiments, the external project application device 110 is configured via hardware, software, firmware, and/or a combination thereof, to generate and/or transmit command(s) that control, adjust, or otherwise impact operations of one or more of the project foundation device 180, the external project implementation device 120, the cloud-based project operations device 140, the one or more databases 150, and/or the user device 170. Additionally, or alternatively, in some embodiments, the external project application device 110 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the cloud-based project operations device 140, the one or more databases 150, and/or the user device 170. For example, in various embodiments, the external project application device 110 may be configured to execute and/or perform one or more operations and/or functions described herein.

In some embodiments, the environment 100 comprises the project foundation device 180. In some embodiments, the project foundation device 180 is electronically and/or communicatively coupled to the external project implementation device 120, the external project application device 110, the cloud-based project operations device 140, the one or more databases 150, and/or the user device 170. The project foundation device 180 may be located remotely from the external project implementation device 120, the external project application device 110, the cloud-based project operations device 140, the one or more databases 150, and/or the user device 170. In this regard, for example, the project foundation device 180 may be located in a remote cloud server and electronically and/or communicatively coupled to the external project implementation device 120, the external project application device 110, the cloud-based project operations device 140, the one or more databases 150, and/or the user device 170 via at least the network 130. In some embodiments, the project foundation device 180 is configured via hardware, software, firmware, and/or a combination thereof, to perform data intake of one or more types of data.

Additionally, or alternatively, in some embodiments, the project foundation device 180 is configured via hardware, software, firmware, and/or a combination thereof, to generate and/or transmit command(s) that control, adjust, or otherwise impact operations of one or more of the external project implementation device 120, the external project application device 110, the cloud-based project operations device 140, the one or more databases 150, and/or the user device 170. Additionally, or alternatively, in some embodiments, the project foundation device 180 is configured via hardware, software, firmware, and/or a combination thereof, to perform data reporting, provide data, and/or other data output process(es) associated with monitoring or otherwise analyzing operations of one or more of the external project implementation device 120, the external project application device 110, the cloud-based project operations device 140, the one or more databases 150, and/or the user device 170. For example, in various embodiments, the project foundation device 180 may be configured to execute and/or perform one or more operations and/or functions described herein.

The one or more databases 150 may be configured to receive, store, and/or transmit data. In some embodiments, the one or more databases 150 may be associated with data associated with the project foundation device 180, the external project implementation device 120, the external project application device 110, the cloud-based project operations device 140, and/or the user device 170. In some embodiments, the data may be received from the project foundation device 180, the external project implementation device 120, the external project application device 110, the cloud-based project operations device 140, and/or the user device 170. In some embodiments, the one or more databases 150 may be associated with data received from the project foundation device 180, the external project implementation device 120, the external project application device 110, the cloud-based project operations device 140, and/or the user device 170 in real-time. Additionally, or alternatively, the one or more databases 150 may be associated with data received from the project foundation device 180, the external project implementation device 120, the external project application device 110, the cloud-based project operations device 140, and/or the user device 170 on a periodic basis (e.g., the data may be received from the project foundation device 180, the external project implementation device 120, the external project application device 110, the cloud-based project operations device 140, the one or more databases 150, and/or the user device 170 once per day). Additionally, or alternatively, the one or more databases 150 may be associated with data received from the project foundation device 180, the external project implementation device 120, the external project application device 110, the cloud-based project operations device 140, and/or the user device 170 in response to a request for the data. Additionally, or alternatively, the one or more databases 150 may be associated with data inputted (e.g., by a user) into the project foundation device 180, the external project implementation device 120, the external project application device 110, the cloud-based project operations device 140, and/or the user device 170.

The user device 170 may be associated with users of the project foundation device 180, the external project implementation device 120, the external project application device 110, the cloud-based project operations device 140, and/or the one or more databases 150. In various embodiments, the project foundation device 180, the external project implementation device 120, the external project application device 110, the cloud-based project operations device 140, and/or the one or more databases 150 may generate and/or transmit a message, alert, or indication to a user via a user device 170. Additionally, or alternatively, a user device 170 may be utilized by a user to remotely access the project foundation device 180, the external project implementation device 120, the external project application device 110, the cloud-based project operations device 140, and/or the one or more databases 150. This may be by, for example, an application operating on the user device 170. A user may access the project foundation device 180, the external project implementation device 120, the external project application device 110, the cloud-based project operations device 140, and/or the one or more databases 150, remotely, including one or more visualizations, reports, and/or real-time displays.

In some embodiments, the project foundation device 180, the external project implementation device 120, the external project application device 110, the cloud-based project operations device 140, the one or more databases 150, and/or the user device 170 is associated with a determinable location. In some embodiments, the determinable location of the project foundation device 180, the external project implementation device 120, the external project application device 110, the cloud-based project operations device 140, the one or more databases 150, and/or the user device 170 represents an absolute position (e.g., GPS coordinates, latitude, and longitude locations, and/or the like) and/or a relative position (e.g., a point representation of the location of the project foundation device 180, the external project implementation device 120, the external project application device 110, the cloud-based project operations device 140, the one or more databases 150, and/or the user device 170 from a local origin point). In some embodiments, the project foundation device 180, the external project implementation device 120, the external project application device 110, the cloud-based project operations device 140, the one or more databases 150, and/or the user device 170 includes or otherwise is associated with a location sensor and/or software-driven location services that provide the location data representing the location corresponding to that the project foundation device 180, the external project implementation device 120, the external project application device 110, the cloud-based project operations device 140, the one or more databases 150, and/or the user device 170. In other embodiments the location of the project foundation device 180, the external project implementation device 120, the external project application device 110, the cloud-based project operations device 140, the one or more databases 150, and/or the user device 170 is stored and/or otherwise predetermined within a software environment, provided by a user and/or otherwise determinable to one or more systems.

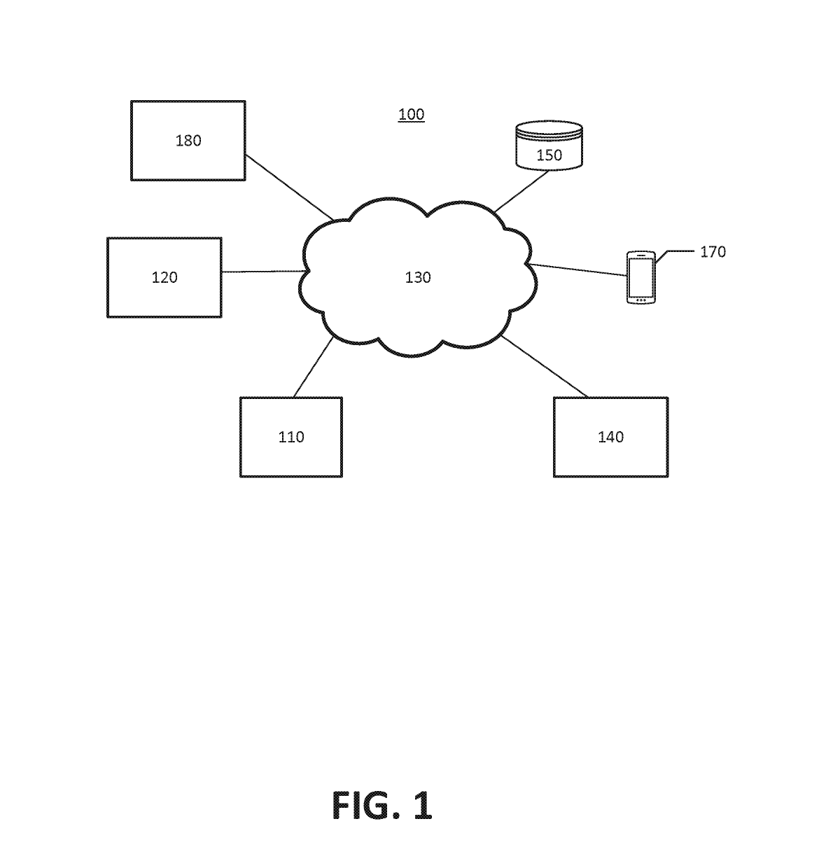

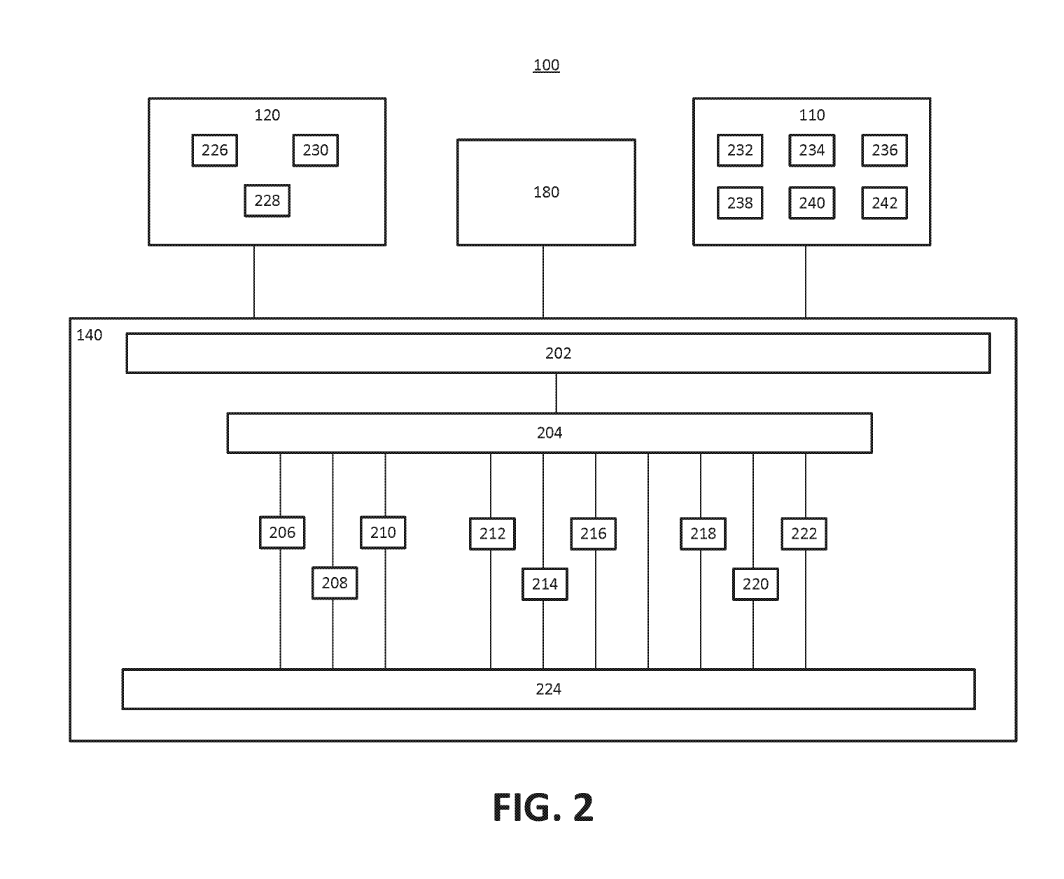

Additionally, while FIGS. 1 and 2 illustrate certain components as separate, standalone entities communicating over the network 130, various embodiments are not limited to this configuration. In other embodiments, one or more components may be directly connected and/or share hardware or the like.

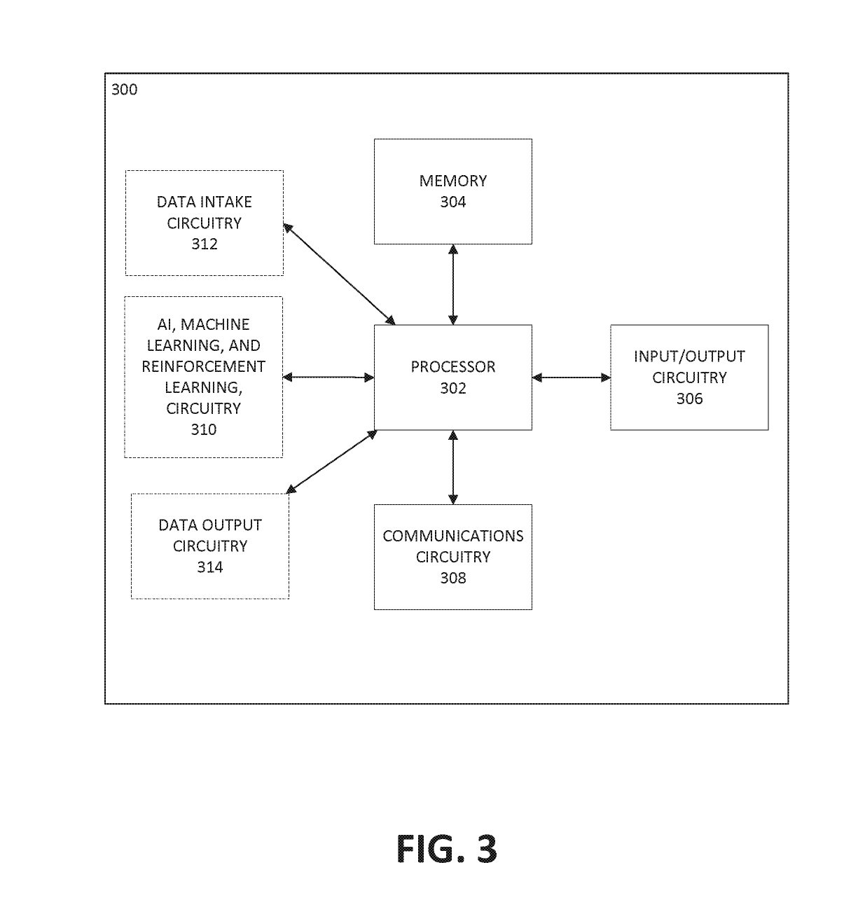

FIG. 3 illustrates an exemplary block diagram of an example apparatus that may be specially configured in accordance with an example embodiment of the present disclosure. Specifically, FIG. 3 depicts an example computing apparatus 300 (“apparatus 300”) specially configured in accordance with at least some example embodiments of the present disclosure. For example, the computing apparatus 300 may be embodied as one or more of a specifically configured personal computing apparatus, a specifically configured cloud-based computing apparatus, a specifically configured embedded computing device (e.g., configured for edge computing, and/or the like). Examples of an apparatus 300 may include, but is not limited to, the project foundation device 180, the external project implementation device 120, the external project application device 110, the cloud-based project operations device 140, the one or more databases 150, and/or the user device 170. The apparatus 300 includes processor 302, memory 304, input/output circuitry 306, communications circuitry 308, and/or optional artificial intelligence (“AI”) and machine learning circuitry 310. In some embodiments, the apparatus 300 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 300 of the project foundation device 180, the external project implementation device 120, the external project application device 110, the cloud-based project operations device 140, the one or more databases 150, and/or the user device 170 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 300 embodies a particular, specially configured computing entity transformed to enable the specific operations described herein and provide the specific advantages associated therewith, as described herein.

Processor 302 or processor circuity 302 may be embodied in a number of different ways. In various embodiments, the use of the terms “processor” should be understood to include a single core processor, a multi-core processor, multiple processors internal to the apparatus 300, and/or one or more remote or “cloud” processor(s) external to the apparatus 300. In some example embodiments, processor 302 may include one or more processing devices configured to perform independently. Alternatively, or additionally, processor 302 may include one or more processor(s) configured in tandem via a bus to enable independent execution of operations, instructions, pipelining, and/or multithreading.

In an example embodiment, the processor 302 may be configured to execute instructions stored in the memory 304 or otherwise accessible to the processor. Alternatively, or additionally, the processor 302 may be configured to execute hard-coded functionality. As such, whether configured by hardware or software methods, or by a combination thereof, processor 302 may represent an entity (e.g., physically embodied in circuitry) capable of performing operations according to embodiments of the present disclosure while configured accordingly. Alternatively, or additionally, processor 302 may be embodied as an executor of software instructions, and the instructions may specifically configure the processor 302 to perform the various algorithms embodied in one or more operations described herein when such instructions are executed. In some embodiments, the processor 302 includes hardware, software, firmware, and/or a combination thereof that performs one or more operations described herein.

In some embodiments, the processor 302 (and/or co-processor or any other processing circuitry assisting or otherwise associated with the processor) is/are in communication with the memory 304 via a bus for passing information among components of the apparatus 300.

Memory 304 or memory circuitry 304 may be non-transitory and may include, for example, one or more volatile and/or non-volatile memories. In some embodiments, the memory 304 includes or embodies an electronic storage device (e.g., a computer readable storage medium). In some embodiments, the memory 304 is configured to store information, data, content, applications, instructions, or the like, for enabling an apparatus 300 to carry out various operations and/or functions in accordance with example embodiments of the present disclosure.

Input/output circuitry 306 may be included in the apparatus 300. In some embodiments, input/output circuitry 306 may provide output to the user and/or receive input from a user. The input/output circuitry 306 may be in communication with the processor 302 to provide such functionality. The input/output circuitry 306 may comprise one or more user interface(s). In some embodiments, a user interface may include a display that comprises the interface(s) rendered as a web user interface, an application user interface, a user device, a backend system, or the like. In some embodiments, the input/output circuitry 306 also includes a keyboard, a mouse, a joystick, a touch screen, touch areas, soft keys a microphone, a speaker, or other input/output mechanisms. The processor 302 and/or input/output circuitry 306 comprising the processor may be configured to control one or more operations and/or functions of one or more user interface elements through computer program instructions (e.g., software and/or firmware) stored on a memory accessible to the processor (e.g., memory 304, and/or the like). In some embodiments, the input/output circuitry 306 includes or utilizes a user-facing application to provide input/output functionality to a computing device and/or other display associated with a user.

Communications circuitry 308 may be included in the apparatus 300. The communications circuitry 308 may include any means such as a device or circuitry embodied in either hardware or a combination of hardware and software that is configured to receive and/or transmit data from/to a network and/or any other device, circuitry, or module in communication with the apparatus 300. In some embodiments the communications circuitry 308 includes, for example, a network interface for enabling communications with a wired or wireless communications network. Additionally, or alternatively, the communications circuitry 308 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 308 may include circuitry for interacting with an antenna(s) and/or other hardware or software to cause transmission of signals via the antenna(s) and/or to handle receipt of signals received via the antenna(s). In some embodiments, the communications circuitry 308 enables transmission to and/or receipt of data from a user device, one or more sensors, and/or other external computing device(s) in communication with the apparatus 300.

Data intake circuitry 312 may be included in the apparatus 300. The data intake circuitry 312 may include hardware, software, firmware, and/or a combination thereof, designed and/or configured to capture, receive, request, and/or otherwise gather data associated with operations of the project foundation device 180, the external project implementation device 120, the external project application device 110, the cloud-based project operations device 140, the one or more databases 150, and/or the user device 170. In some embodiments, the data intake circuitry 312 includes hardware, software, firmware, and/or a combination thereof, that communicates with one or more sensor(s) unit(s), and/or the like within the project foundation device 180, the external project implementation device 120, the external project application device 110, the cloud-based project operations device 140, the one or more databases 150, and/or the user device 170 to receive particular data. Additionally, or alternatively, in some embodiments, the data intake circuitry 312 includes hardware, software, firmware, and/or a combination thereof, that retrieves particular data associated with the project foundation device 180, the external project implementation device 120, the external project application device 110, the cloud-based project operations device 140, the one or more databases 150, and/or the user device 170 from one or more data repository/repositories accessible to the apparatus 300.

AI and machine learning circuitry 310 may be included in the apparatus 300. The AI and machine learning circuitry 310 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 310 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 310 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 310 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 314 may be included in the apparatus 300. The data output circuitry 314 may include hardware, software, firmware, and/or a combination thereof, that configures and/or generates an output based at least in part on data processed by the apparatus 300. In some embodiments, the data output circuitry 314 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 314 includes hardware, software, firmware, and/or a combination thereof, that configures a particular output data object, output data file, and/or user interface for storing, transmitting, and/or displaying. For example, in some embodiments, the data output circuitry 314 generates and/or specially configures a particular data output for transmission to another system sub-system for further processing. Additionally, or alternatively, in some embodiments, the data output circuitry 314 includes hardware, software, firmware, and/or a combination thereof, that causes rendering of a specially configured user interface based at least in part on data received by and/or processing by the apparatus 300.

In some embodiments, two or more of the sets of circuitries 302-314 are combinable. Alternatively, or additionally, one or more of the sets of circuitry 302-314 perform some or all of the operations and/or functionality described herein as being associated with another circuitry. In some embodiments, two or more of the sets of circuitry 302-314 are combined into a single module embodied in hardware, software, firmware, and/or a combination thereof. For example, in some embodiments, one or more of the sets of circuitry, for example the AI and machine learning circuitry 310, may be combined with the processor 302, such that the processor 302 performs one or more of the operations described herein with respect to the AI and machine learning circuitry 310.

With reference to FIGS. 1-6, in some embodiments, a project may be a collection of components that may be implemented in a configured manner to accomplish one or more tasks. In this regard, for example, a project may be a collection of components that may be implemented in a configured manner in order to control the temperature of a building. For example, a project may be a collection of configured components that include temperature sensors, temperature control systems, circuits, and/or heating, ventilation, and air conditioning (HVAC) units that may be implemented in order to control the temperature of a building.

In some embodiments, the cloud-based project operations device 140 is configured to access one or more requirement electronic records. For example, the cloud-based project operations device 140 may be configured to access one or more requirement electronic records at the project orchestration predictive computing entity 204 (e.g., the cloud-based project operations device 140 is configured to access one or more requirement electronic records using the project orchestration predictive computing entity 204).

In some embodiments, a requirement electronic record comprises an electronic record that is representative of one or more requirement features (e.g., a requirement electronic record comprises one or more electronic records). In this regard, in some embodiments, a requirement electronic record may be one or more of a text document, a schematic drawing, a 3D model, a computer-aided design (CAD) file, an image, a video, and/or the like. For example, a requirement electronic record may be a schematic drawing that depicts one or more requirement features. As another example, a requirement electronic record may be a video that depicts one or more requirement features. As another example, a requirement electronic record may be a text document that describes one or more requirement features. As another example, a requirement electronic record may be a 3D model that depicts one or more requirement features. As another example, requirement electronic record may be a computer-aided design (CAD) file that describes and/or depicts one or more requirement features. As another example, requirement electronic record may be an image that depicts one or more requirement features.

In some embodiments, a requirement feature comprises one or more items of data representative of a requirement, a criteria, and/or a constraint that must be satisfied in order to implement a proposed project (e.g., a project that has not yet been implemented). For example, a requirement feature may be one or more items of data that are representative of a requirement, a criteria, and/or a constraint that must be satisfied in order to implement a proposed project that includes controlling the temperature of a building. In this regard, for example, a requirement feature may be representative of a particular range in which the temperature of a building must be controlled to stay within (e.g., a requirement). As another example, requirement feature may be representative of a physical layout of a building in which the temperature is to be controlled (e.g., a constraint).

In some embodiments, accessing one or more requirement electronic records comprises the cloud-based project operations device 140 being configured to retrieve one or more requirement electronic records. For example, the cloud-based project operations device 140 may be configured to retrieve one or more requirement electronic records from the one or more databases 150 using the project orchestration predictive computing entity 204. As another example, the cloud-based project operations device 140 may be configured to retrieve one or more requirement electronic records from the internal databases 224 using the project orchestration predictive computing entity 204. In some embodiments, accessing one or more requirement electronic records comprises the cloud-based project operations device 140 being configured to receive one or more requirement electronic records. For example, the cloud-based project operations device 140 may be configured to receive one or more requirement electronic records from the project foundation device 180. In some embodiments, prior to the cloud-based project operations device 140 accessing one or more requirement electronic records at the project orchestration predictive computing entity 204, at least one of the one or more requirement electronic records may be processed by the project operations security layer 202 using one or more cybersecurity operations.

In some embodiments, the cloud-based project operations device 140 is configured to identify an archived project electronic record. In some embodiments, an archived project electronic record comprises an electronic record that describes a completed, previous, and/or archived project. In this regard, in some embodiments, an archived project electronic record is representative of a collection of archived project components that were implemented in the completed, previous, and/or archived project associated with the archived project electronic record. For example, an archived project electronic record may be representative of a collection of archived project components that include temperature sensors, temperature control systems, circuits, and/or heating, ventilation, and air conditioning (HVAC) units that have been configured to control the temperature of a building. Said differently, for example, an archived project electronic record may be representative of an archived project component that formed a portion of a completed, previous, and/or archived project.

In some embodiments, the cloud-based project operations device 140 is configured to identify an archived project electronic record using the project record predictive computing entity 212. In some embodiments, the cloud-based project operations device 140, using the project record predictive computing entity 212, is configured to identify an archived project electronic record by performing at least one electronic filtering operation of a set of electronic filtering operations. In some embodiments, the cloud-based project operations device 140, using the project record predictive computing entity 212, is configured to identify an archived project electronic record based on a requirement electronic record. In this regard, in some embodiments, the cloud-based project operations device 140, using the project record predictive computing entity 212, is configured to perform one or more of the set of electronic filtering operations based on a requirement electronic record.

In some embodiments, the set of electronic filtering operations comprises a text-based filtering operation. In some embodiments, a text-based filtering operation comprises identifying a first sequence of characters from a requirement electronic record using an optical character recognition (OCR) technique. In some embodiments, a text-based filtering operation comprises identifying one or more other sequences of characters from one or more archived project electronic records using an optical character recognition (OCR) technique. In some embodiments, a text-based filtering operation comprises comparing the first sequence of characters with one or more of the one or more other sequences of characters. In this regard, for example, the cloud-based project operations device 140 may identify an archived project electronic record by finding a match between the first sequence of characters and the one or more of the one or more other sequences of characters. In some embodiments, the cloud-based project operations device 140 may leverage the project extraction predictive computing entity 226 to execute an optical character recognition (OCR) technique (e.g., the project extraction predictive computing entity 226 may be configured to perform an optical character recognition (OCR) technique).

In some embodiments, the set of electronic filtering operations comprises a geometry-based filtering operation. In some embodiments, a geometry-based filtering operation comprises identifying a geometric element from a requirement electronic record. In some embodiments, a geometry-based filtering operation comprises identifying one or more other geometric elements from one or more archived project electronic records. In some embodiments, a geometry-based filtering operation comprises comparing the geometric element with one or more of the one or more other geometric elements. In this regard, for example, the cloud-based project operations device 140 may identify an archived project electronic record by finding a match between the geometric element and the one or more of the one or more other geometric elements.

In some embodiments, the set of electronic filtering operations comprises a design-based filtering operation. In some embodiments, a design-based filtering operation comprises identifying a data encoding from a requirement electronic record. For example, a data encoding may comprise one or more of an svg, .dwg, .tiff, .png, .obj, .amf, .stl, and/or .glb data encoding. In some embodiments, a design-based filtering operation comprises identifying one or more other data encodings from one or more archived project electronic records. In some embodiments, a design-based filtering operation comprises comparing the data encoding with one or more of the one or more other data encodings. In this regard, for example, the cloud-based project operations device 140 may identify an archived project electronic record by finding a match between the data encoding and the one or more of the one or more other data encodings.

In some embodiments, the set of electronic filtering operations comprises a sketch-based filtering operation. In some embodiments, a sketch-based filtering operation comprises identifying a sketch feature from a requirement electronic record. For example, a sketch feature may be representative of a feature of a sketch or 3D model. In some embodiments, a sketch-based filtering operation comprises identifying one or more other sketch features from one or more archived project electronic records. In some embodiments, a sketch-based filtering operation comprises comparing the sketch feature with one or more of the one or more other sketch features. In this regard, for example, the cloud-based project operations device 140 may identify an archived project electronic record by finding a match between the sketch feature and the one or more of the one or more other sketch features.

In some embodiments, the set of electronic filtering operations comprises a topology-based filtering operation. In some embodiments, a topology-based filtering operation comprises identifying a topology feature from a requirement electronic record. For example, topology feature may be data representative of a component configuration, architecture indicating connections between several components, and/or an organization of information in an electronic record. In some embodiments, a topology-based filtering operation comprises identifying one or more other topology features from one or more archived project electronic records. In some embodiments, a topology-based filtering operation comprises comparing the topology feature with one or more of the one or more other topology features. In this regard, for example, the cloud-based project operations device 140 may identify an archived project electronic record by finding a match between the topology feature and the one or more of the one or more other topology features.

In some embodiments, the set of electronic filtering operations comprises a color-based filtering operation. In some embodiments, a color-based filtering operation comprises identifying first pixel data from a requirement electronic record. In some embodiments, a color-based filtering operation comprises identifying other pixel data from one or more archived project electronic records. For example, first pixel data and/or other pixel data may be representative of colors, color usage patterns, and/or color coordinates in an electronic record. In some embodiments, a color-based filtering operation comprises comparing the first pixel data with the other pixel data. In this regard, for example, the cloud-based project operations device 140 may identify an archived project electronic record by finding a match between the first pixel data and the other pixel data.

In some embodiments, a requirement feature comprises one or more items of data representative of a requirement, a criteria, and/or a constraint that must be satisfied in order to implement a proposed project (e.g., a project that has not yet been implemented). For example, a requirement feature may be one or more items of data that are representative of a requirement, a criteria, and/or a constraint that must be satisfied in order to implement a proposed project that includes controlling the temperature of a building. In this regard, for example, a requirement feature may be representative of a particular range in which the temperature of a building must be controlled to stay within (e.g., a requirement). As another example, requirement feature may be representative of a physical layout of a building in which the temperature is to be controlled (e.g., a constraint).

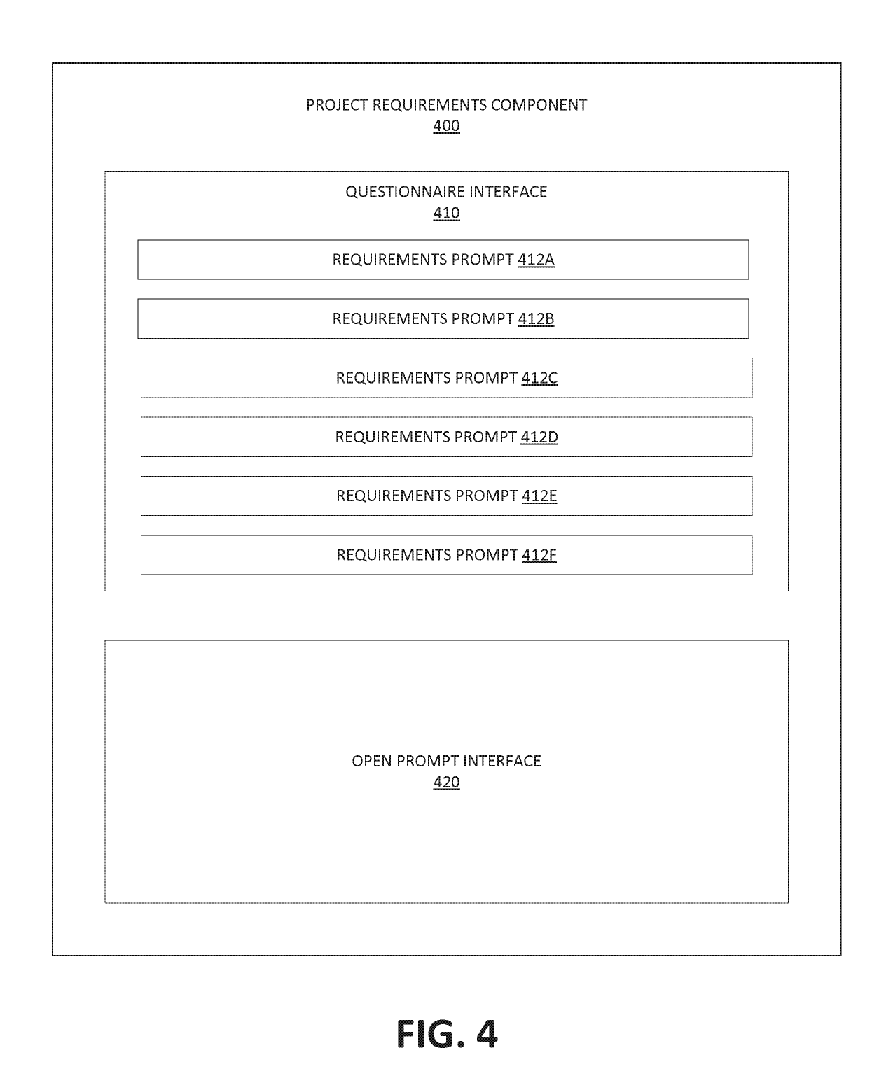

FIG. 4 illustrates an example project requirements component 400 that may be specially configured in accordance with an example embodiment of the present disclosure. As depicted, project requirements component 400 includes a questionnaire interface 410 and an open prompt interface 420. It should be appreciated that various embodiments of the project requirements component 400 may include either questionnaire interface 410 or open prompt interface 420 individually, or may include a component providing the functionality of both questionnaire interface 410 and open prompt interface 420. In general, project requirements component 400 is configured to facilitate user input(s) defining any number of project requirements. Project requirements component 400 may be a component of cloud-based project operations device 140, and/or may be configured to be displayed via the user device 170 and/or external project application device 110. In at least some embodiments, project requirements component 400 corresponds to project condition predictive computing entity 210 as described with respect to FIG. 2.

In some embodiments, the cloud-based project operations device 140 is configured to perform one or more responsive actions based on an updated project proposal. In this regard, in some embodiments, performing one or more responsive actions comprises cloud-based project operations device 140 being configured to cause a component inventory record to be updated. In some embodiments, a component inventory record is a record that indicates one or more physical components that may be included in a project associated with a project proposal. In this regard, for example, a component inventory record may be updated to be associated with an indication that a physical component is necessary for the manufacturing of a project component associated with a project electronic record. As another example, a component inventory record may be updated to cause, by cloud-based project operations device 140 via inventory predictive computing entity 206, procurement of a physical component. In this regard, in some embodiments, causing performance of one or more reconfigured physical component responsive actions may comprise causing one or more manufacturing systems to operate in order to generate a physical component. Additionally, or alternatively, causing performance of one or more physical component responsive actions may comprise causing one or more manufacturing systems to shut down (e.g., after the physical component has been generated).

Questionnaire interface 410 may be a user interface configured to provide one or more interactable elements to a user via which the user can indicate, or otherwise inform, one or more project requirements. In at least some embodiments, questionnaire interface 410 is operably connected to an AI/machine learning component configured to ingest and analyze project context data to determine a set of requirements prompts directed towards additional user provided information. In at least some embodiments, the questionnaire interface 410 (or a connected AI/machine learning component) is configured to analyze project context data corresponding to current project. Questionnaire interface 410 may additionally be configured to analyze historical project requirements data to identify one or more requirements. In at least some embodiments, questionnaire interface 410 is configured to generate a plurality of requirements prompts 412 (e.g., 412A-412F) corresponding to the identified requirements.

Requirements prompts 412 may each be configured to facilitate or otherwise receive user input related to the corresponding identified requirement. In at least some embodiments, each requirements prompt 412 corresponds to a generated prompt via which a user can indicate one or more project requirements. Requirements prompts 412 may include a combination of interactable elements and text descriptions associated with the corresponding requirement(s). In some embodiments, the requirements prompt 412 includes a prompt offering one or more selections a user may select associated with a corresponding requirement. In some embodiments, the requirements prompt 412 may include a field enabling a user to enter text in response to the prompt indicating response and/or details associated with the corresponding requirement.

Open prompt interface 420 may be configured to facilitate or otherwise receive additional user input(s) not associated with the generated requirements prompts 412. In at least some embodiments, open prompt interface 420 is configured to enable a user to enter text indicating one or more additional requirements not reflected by the requirements prompts 412. In at least some embodiments, open prompt interface 420 is configured to facilitate a back-and-forth interaction between a user and an AI/machine learning component, via which said AI/machine learning component may be configured to generate one or more responses to any additional user input(s). For example, a text description of an additional input item provided via the open prompt interface 420 may be processed by a machine learning (ML) component to identify one or more elements requiring additional clarification. Subsequent to said processing, the ML component may be additionally configured to generate a prompt to be provided by the open prompt interface 420, the prompt configured to query the user for additional requirement(s) details.

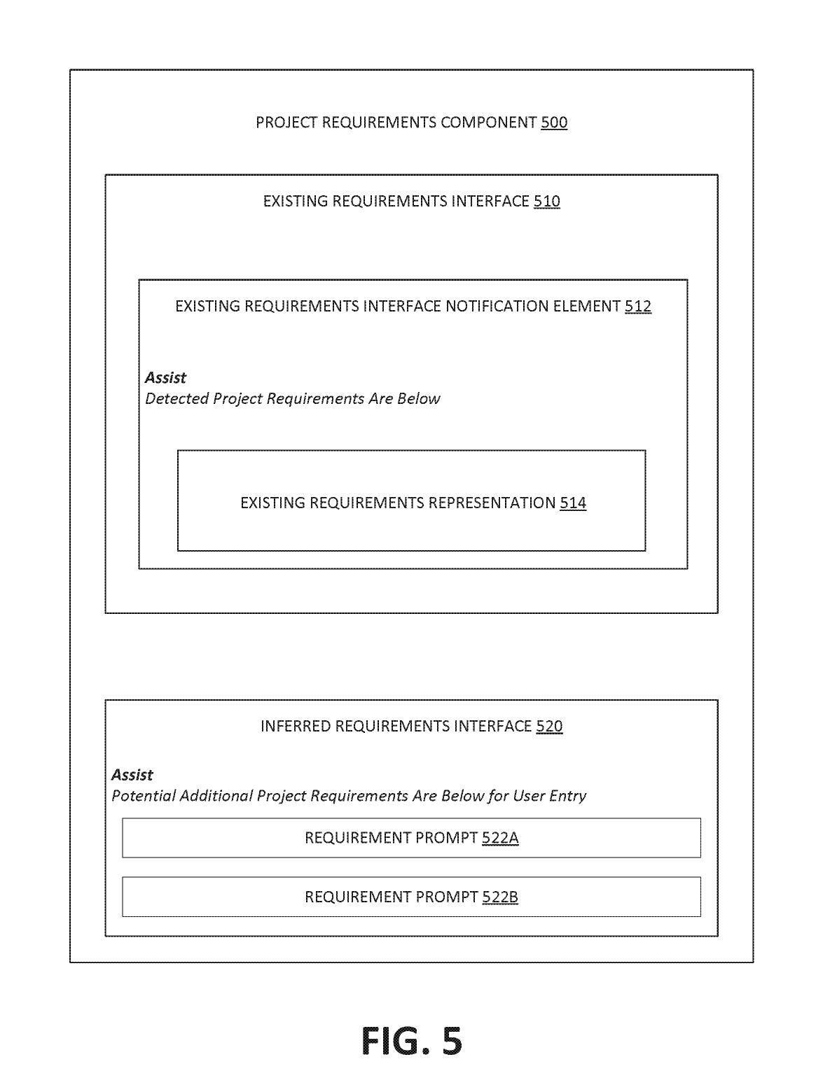

FIG. 5 illustrates an example project requirements component 500 that may be specially configured in accordance with an example embodiment of the present disclosure. As depicted, project requirements component 500 includes an existing requirements interface 510 and an inferred requirements interface 520. It should be appreciated that various embodiments of the project requirements component 500 may include either existing requirements interface 510 or inferred requirements interface 520 individually, or may include a component providing the functionality of both existing requirements interface 510 or inferred requirements interface 520. In general, project requirements component 500 is configured to display detected or determined existing project requirements and further facilitate user input(s) defining any number of project requirements. Project requirements component 500 may be a component of cloud-based project operations device 140, and/or may be configured to be displayed via the user device 170 and/or external project application device 110. In at least some embodiments, project requirements component 500 corresponds to project condition predictive computing entity 210 as described with respect to FIG. 2.

As depicted, existing requirements interface 510 includes an existing requirements interface notification element 512. Existing requirements interface notification element 512 may include one or more generated text strings/text fields indicating and/or introducing detected project requirements. Existing requirements interface notification element 512 may include an existing requirements representation 514, which may be a dedicated field in which one or more detected existing requirements are displayed with corresponding requirement(s) labels and requirement(s) values. In at least some embodiments, existing requirements representation 514 may include an indication of one or more sources via which a corresponding existing/detected requirement was determined, such that a user interacting with the existing requirements interface 510 can readily identify a source requiring correction in embodiments where existing requirements interface 510 reflects an incorrect requirement or requirement value. Existing requirements interface 510 and its various components may be embodied as a chat window with an AI-driven chat module, via which the existing requirements may be presented in conversational form. In at least some embodiments, existing requirements interface 510 is configured to present a set of existing requirements in a single sentence/statement for user consideration; in such embodiments, existing requirements interface 510 may additionally be configured to request that a user confirm the set of existing requirements. Existing requirements interface 510 may be configured to ask a user to provide, via a text input element, an indication of one or more incorrect requirements (if any). In at least some embodiments, existing requirements interface 510 is configured to present each requirement of a set of existing requirements one at a time, such that a user can either confirm or correct each requirement one at a time.

As depicted, inferred requirements interface 520 includes a set of requirement prompts 522 (522A, 522B). Each requirement prompt 522 may include a user-interactable/user-editable text prompt indicating one or more potentially missing requirements determined according to analyzed historical project metadata. For example, in a case where similar historical projects typically include a requirement “Requirement A” which is not present with respect to the existing requirements interface 510, a requirements prompt 522 of inferred requirements interface 520 may include a text prompt querying the user regarding Requirement A. The requirements prompt 522 may enable a user to provide requirement information corresponding to Requirement A. In at least some embodiments, requirements prompt 522 includes a selectable option via which the user may indicate that Requirement A is not required for the subject project. Any number of requirements prompts 522 may be present in various embodiments to accommodate any number of identified missing or incomplete requirements. In general, each requirements prompt 522 is configured to enable user input with respect to identified missing or incomplete requirements. As used herein, missing or incomplete requirements refer to requirements which are present with respect to a historical project that is substantially similar to the subject project, but are not present with respect to the subject project.

### EXAMPLE METHODS

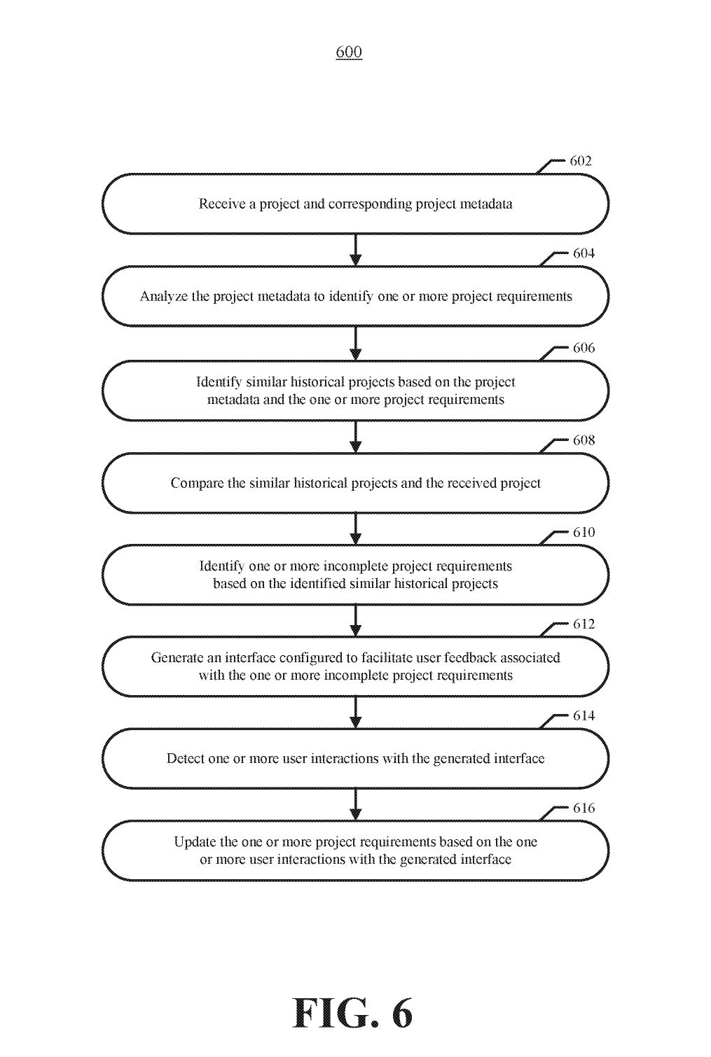

Referring now to FIG. 6, a flowchart providing an example method 600 is illustrated. In this regard, FIG. 6 illustrates operations that may be performed by the project foundation device 180, the external project implementation device 120, the external project application device 110, the cloud-based project operations device 140, the one or more databases 160, and/or the user device 170. In some embodiments, the method 600 comprises operations for configuring a project according to a set of requirements. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600. As depicted, the example method 600 includes receiving (602) a project and corresponding project metadata, analyzing (604) the project metadata to identify one or more project requirements, identifying (606) similar historical projects based on the project metadata and the one or more project requirements, comparing (608) the similar historical projects and the received project, identifying (610) one or more incomplete project requirements, generating (612) an interface configured to facilitate user feedback associated with the one or more incomplete project requirements, detecting (614) one or more user interactions with the generated interface, and updating (616) the one or more project requirements based on the one or more user interactions.

As depicted in block 602, the method 600 includes receiving a project and corresponding project metadata. Receiving (602) a project and corresponding project metadata may include receiving a dataset corresponding to a subject project, the dataset indicating project information corresponding to the subject project. In at least some embodiments, receiving (602) a project and corresponding project metadata includes receiving an electronic record that is representative of one or more requirement features. Such an electronic record may include a text document, a schematic drawing, a 3D model, a computer-aided design (CAD) file, an image, a video, and/or the like. In at least some embodiments, a requirement electronic record is a text document describing one or more requirement features. A requirement electronic record may be a schematic drawing depicting one or more requirement features. In general, receiving a project and corresponding project metadata includes receiving and/or retrieving project information corresponding to a subject project for analysis. In at least some embodiments, receiving (602) a project and corresponding project metadata may include receiving a text document, schematic drawing, 3D model, a CAD file, an image, a video, and/or the like, wherein the received document is not structured in such a manner that readily identifies project requirements. Some electronic records may be organized using defined fields identifying project requirements and/or features, while other electronic records may simply be project descriptions requiring additional analysis to extract project requirements and/or features.

As depicted in block 604, the method 600 includes analyzing the project and the project metadata to identify one or more project requirements. Analyzing (604) the project metadata to identify one or more project requirements may include extracting project requirement information from the received project and corresponding project metadata. In at least some embodiments, analyzing the set of project metadata to identify one or more project requirements includes extracting one or more project features for the set of project metadata. The project features may include one or more data labels indicating pertinent data types/data categories corresponding to the analyzed set of project metadata. In at least some embodiments, analyzing the set of project metadata to identify one or more project requirements includes identifying one or more project requirements corresponding to the one or more project features.

In at least some embodiments, analyzing (604) the project metadata includes leveraging natural language processing (NLP) techniques to analyze one or more text sections of the project information/project metadata to extract one or more project requirements. Appropriate NLP techniques may include part-of-speech tagging, wherein NLP modules tag individual words in a sentence according to contextual usages, such as nouns, verbs, adjectives, or adverbs, enabling improved analysis of relationships between individual terms. Appropriate NLP techniques may further include word-sense disambiguation techniques, wherein NLP modules identify a word’s intended meaning according to its contextual data and a trained language model. Appropriate NLP techniques may further include speech recognition techniques in embodiments wherein project information is received in an audio file and/or a video file comprising speech audio. Appropriate speech recognition techniques may include, but are not limited to, breaking down words into smaller parts and utterances and understanding accents, slurs, intonation, and nonstandard grammar usage in everyday conversation. In at least some embodiments, speech recognition techniques as leveraged include using speech-to-text services to generate a transcription of audio data describing the subject project. In at least some embodiments, appropriate NLP techniques further include leveraging machine translation software to convert text or speech from one language to another while retaining contextual accuracy. In at least some embodiments, appropriate NLP techniques may further include named-entity recognition techniques, which identify unique names for entities in a sentence and using co-reference resolution to determine if different words are used to describe a same entity. Appropriate NLP techniques may further include sentiment analysis, which includes using artificial intelligence to interpret emotions conveyed by textual data.

In some embodiments, the trained language model comprises hardware and/or software that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to analyze one or more text sections of the project information/project metadata to extract one or more project requirements. In this regard, in some embodiments, the trained language model may be configured to utilize one or more of any type of machine learning, rules-based, and/or artificial intelligence techniques including one or more of clustering techniques (e.g., k-means techniques, expectation maximization techniques, centroid neural network techniques), computer vision techniques, supervised learning (e.g., using user feedback), unsupervised learning, semi-supervised learning, reinforcement learning, sequence modeling techniques, language processing techniques, neural network techniques, and/or generative artificial intelligence techniques.

In at least some embodiments, appropriate NLP techniques may include supervised NLP methods, via which the NLP modules are trained with a set of labeled or known inputs and outputs. In supervised NLP methods, the NLP modules process the known data and learn how to produce the correct output from any unknown input. In at least some embodiments, appropriate NLP techniques include unsupervised NLP methods, via which the NLP modules are configured to use a statistical language model to predict a pattern that occurs when they are fed a non-labeled input.

As depicted in block 606, the method 600 includes identifying similar historical projects based on the project metadata and the one or more project requirements. Identifying (606) similar historical projects based on the project metadata and the one or more project requirements may include analyzing a plurality of projects available via a project database, a historical project database, and/or other source of historical project metadata. In at least some embodiments, identifying one or more similar historical projects comprises determining a similarity score between the one or more project features and one or more historical project features of the one or more similar historical projects. Identifying (606) similar historical projects based on the subject project metadata and the one or more project requirements may include, for a subject historical project of the plurality of historical projects, comparing the determined similarity score to a defined similarity score threshold indicating a level of similarity which much be met for two projects to be considered similar. In at least some embodiments, identifying similar historical projects based on the project metadata and the one or more project requirements includes identifying similar historical projects according to a subset of the one or more project features identified as most pertinent to determining project similarity. In at least some embodiments, one or more features may be weighted more heavily than others when determining project similarity. For example, an authority responsible for issuing a project may be weighted more heavily than other features, as the issuing authority may provide a more applicable subset of potentially pertinent features than other features or categories.

As depicted in block 608, the method 600 includes comparing the similar historical projects and the received project. Comparing (608) the similar historical projects and the received project may include comparing the project features of the subject (received) project to one or more historical project features of each of the similar historical projects to determine whether the historical projects include features which are not present with respect to the subject project.

As depicted in block 610, the method 600 includes identifying one or more incomplete project requirements. Identifying (610) one or more incomplete project requirements may include analyzing the one or more similar historical projects to identify one or more historical project requirements which are not included in the one or more project requirements. In at least some embodiments, identifying (610) one or more incomplete project requirements includes, for a subject missing feature, whether a substantially similar feature/requirement exists with respect to the subject project. For example, if a historical project includes a “time to completion” feature, whereas the subject project includes a “deadline for completion” feature, these features may be considered substantially similar as they can be readily derived from one another. As such, though the historical project includes a “time to completion” feature which is not explicitly present in the subject project, “time to completion” may not be considered an incomplete project requirement, as the “deadline for completion” feature is substantially similar. Further, in at least some embodiments, identifying (610) one or more incomplete project requirements may include translating a subject project feature into a format that matches a substantially similar historical project feature, such that the requirements data can be presented in a consistent format.

As depicted in block 612, the method 600 includes generating an interface configured to facilitate user feedback associated with the one or more incomplete project requirements. Generating (612) an interface configured to facilitate user feedback associated with the one or more incomplete project requirements may include generating a user-interactable interface via which a user can provide project requirement data. In at least some embodiments, generating (612) an interface configured to facilitate user feedback associated with the one or more incomplete project requirements includes leveraging natural language generation (NLG) methods to produce conversational text prompts or questions associated with the identified one or more incomplete project requirements. In at least some embodiments, generating (612) leveraging NLG methods to produce conversational text prompts associated with the one or more incomplete project requirements includes generating, via a chat interface for example, a prompt interface via which a user can (i) receive conversational prompts configured to query the user regarding the one or more incomplete project requirements, and (ii) provide project requirements information/data corresponding to the one or more incomplete project requirements.

As depicted in block 614, the method 600 includes detecting one or more user interactions with the generated interface. Detecting (614) one or more user interactions with the generated interface may include receiving a user selection of one or more selectable components of the generated interface. For example, detecting (614) one or more user interactions with the generated interface may include receiving an indication, via a cursor, touch screen element, or other input device, that a user has selected a selectable component enabling the user to indicate whether a corresponding incomplete project requirement is pertinent. In at least some embodiments, a user may select an interactable component indicating that the subject incomplete project requirement does not require additional information. Subsequent to such an interaction, the generated interface may be configured to remove prompts associated with subject incomplete project requirement. In at least some embodiments, detecting (614) one or more user interactions with the generated interface includes receiving user text input associated with the subject incomplete project requirement.

As depicted in block 616, the method 600 includes updating the one or more project requirements based on the one or more user interactions. Updating (616) the one or more project requirements based on the one or more user interactions may include updating a project proposal record or document to reflect the updated project requirements according to the detected one or more user interactions. In at least some embodiments, the method 600 may further include generating an updated project proposal corresponding to the subject project. Generating an updated project proposal may include editing an existing project proposal record or document to add project requirements/project requirements information based on the detected one or more user interactions. In at least some embodiments, the method 600 further includes transmitting the updated project proposal comprising the one or more updated project requirements to an external system, such as a client device (e.g., the project foundation device 180)

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A computer-implemented method comprising:
receiving, by one or more processors, a subject project and a set of project metadata corresponding to the subject project;
analyzing, by the one or more processors, the set of project metadata to identify one or more project requirements;
identifying, by the one or more processors, one or more similar historical projects based at least in part on the set of project metadata and the one or more project requirements;
detecting, by the one or more processors, one or more incomplete project requirements based on the identified one or more similar historical projects;
generating, by the one or more processors, an interface comprising one or more prompts configured to facilitate user feedback associated with the one or more incomplete project requirements;
detecting, by the one or more processors, one or more user interactions with the generated interface; and
generating, by the one or more processors, one or more updated project requirements based on the one or more user interactions and the one or more incomplete project requirements.

2. The computer-implemented method of claim 1, wherein analyzing the set of project metadata to identify one or more project requirements comprises:
extracting one or more project features from the set of project metadata; and
identifying one or more project requirements corresponding to the one or more project features.

3. The computer-implemented method of claim 2, wherein identifying one or more similar historical projects comprises:
for each subject historical project of a plurality of historical projects available via a historical project database, determining a similarity score between the one or more project features and one or more historical project features of the subject historical project; and
identifying one or more similar historical projects of the plurality of historical projects based at least in part on the similarity score exceeding a defined similarity score threshold.

4. The computer-implemented method of claim 1, wherein detecting one or more incomplete project requirements based on the identified one or more similar historical projects comprises:
analyzing the one or more similar historical projects to identify one or more historical project requirements which are not included in the one or more project requirements.

5. The computer-implemented method of claim 1, wherein generating an interface comprising one or more prompts configured to facilitate user feedback associated with the one or more incomplete project requirements comprises:
generating one or more user-editable text prompts via which a user can provide project requirements information corresponding to the one or more incomplete project requirements.

6. The computer-implemented method of claim 1, further comprising:
generating, by the one or more processors, an updated project proposal comprising the one or more updated project requirements.

7. The computer-implemented method of claim 6, further comprising:
transmitting, by the one or more processors, the updated project proposal comprising the one or more updated project requirements to an external system.

8. An apparatus comprising memory and one or more processors communicatively coupled to the memory, the one or more processors configured to perform operations comprising:
receiving a subject project and a set of project metadata corresponding to the subject project;
analyzing the set of project metadata to identify one or more project requirements;
identifying one or more similar historical projects based at least in part on the set of project metadata and the one or more project requirements;
detecting one or more incomplete project requirements based on the identified similar historical projects;
generating an interface comprising one or more prompts configured to facilitate user feedback associated with the one or more incomplete project requirements;
detecting one or more user interactions with the generated interface; and
generating one or more updated project requirements based on the one or more user interactions and the one or more incomplete project requirements.

9. The apparatus of claim 8, wherein analyzing the set of project metadata to identify one or more project requirements comprises:
extracting one or more project features from the set of project metadata; and
identifying one or more project requirements corresponding to the one or more project features.

10. The apparatus of claim 9, wherein identifying one or more similar historical projects comprises:
for each subject historical project of a plurality of historical projects available via a historical project database, determining a similarity score between the one or more project features and one or more historical project features of the subject historical project; and
identifying one or more similar historical projects of the plurality of historical projects based at least in part on the similarity score exceeding a defined similarity score threshold.

11. The apparatus of claim 8, wherein detecting one or more incomplete project requirements based on the identified one or more similar historical projects comprises:
analyzing the one or more similar historical projects to identify one or more historical project requirements which are not included in the one or more project requirements.

12. The apparatus of claim 8, wherein generating an interface comprising one or more prompts configured to facilitate user feedback associated with the one or more incomplete project requirements comprises:
generating one or more user-editable text prompts via which a user can provide project requirements information corresponding to the one or more incomplete project requirements.

13. The apparatus of claim 8, the operations further comprising:
generating an updated project proposal comprising the one or more updated project requirements.

14. The apparatus of claim 13, the operations further comprising:
transmitting the updated project proposal comprising the one or more updated project requirements to an external system.

15. A computer program product comprising at least one non-transitory computer-readable storage medium having computer program code stored thereon that, in execution with at least one processor, configures the computer program product for:
receiving a subject project and a set of project metadata corresponding to the subject project;
analyzing the set of project metadata to identify one or more project requirements;
identifying one or more similar historical projects based at least in part on the set of project metadata and the one or more project requirements;
detecting one or more incomplete project requirements based on the identified similar historical projects;
generating an interface comprising one or more prompts configured to facilitate user feedback associated with the one or more incomplete project requirements;
detecting one or more user interactions with the generated interface; and
generating one or more updated project requirements based on the one or more user interactions and the one or more incomplete project requirements.

16. The computer program product of claim 15, wherein analyzing the set of project metadata to identify one or more project requirements comprises:
extracting one or more project features from the set of project metadata; and
identifying one or more project requirements corresponding to the one or more project features.

17. The computer program product of claim 16, wherein identifying one or more similar historical projects comprises:
for each subject historical project of a plurality of historical projects available via a historical project database, determining a similarity score between the one or more project features and one or more historical project features of the subject historical project; and
identifying one or more similar historical projects of the plurality of historical projects based at least in part on the similarity score exceeding a defined similarity score threshold.

18. The computer program product of claim 15, wherein detecting one or more incomplete project requirements based on the identified one or more similar historical projects comprises:
analyzing the one or more similar historical projects to identify one or more historical project requirements which are not included in the one or more project requirements.

19. The computer program product of claim 15, wherein generating an interface comprising one or more prompts configured to facilitate user feedback associated with the one or more incomplete project requirements comprises:
generating one or more user-editable text prompts via which a user can provide project requirements information corresponding to the one or more incomplete project requirements.

20. The computer program product of claim 15, the at least one non-transitory computer-readable storage medium having computer program code stored thereon that, in execution with at least one processor, further configures the computer program product for:
generating an updated project proposal comprising the one or more updated project requirements; and
transmitting the updated project proposal comprising the one or more updated project requirements to an external system.
